(19) United States
(12) Patent Application Publication
(10) Pub. No.: US 2014/0124444 A1
(43) Pub. Date: May 8, 2014

(54) SINTERED METAL FIBER DISKS FOR CHROMATOGRAPHIC APPLICATIONS

(71) Applicant: Phenomenex, Inc., (US)

(72) Inventors: Jason Anspach, Torrance, CA (US); Ismail Rutamov, Torrance, CA (US); Allen Bischofberger, Torrance, CA (US); Mark Brown, Torrance, CA (US); Jeff Layne, Torrance, CA (US); Emmet Welsh, Torrance, CA (US); Tivadar Farkas, Torrance, CA (US)

(73) Assignee: PHENOMENEX, INC., Torrance, CA (US)

(21) Appl. No.: 13/842,834

(22) Filed: Mar. 15, 2013

Related U.S. Application Data
(60) Provisional application No. 61/723,251, filed on Nov. 6, 2012.

(51) Int. Cl. G01N 30/60

(52) U.S. Cl. CPC G01N 30/6052
USPC 210/656; 210/198.2

(57) ABSTRACT

A chromatography column has an upstream frit made of non-woven, metal fibers sintered to form a depth filter having graded interstitial passages increasing in size in the direction of flow through the column during use. The frit is held in the column or in a recess of an end fitting, insert or PEEK holder. An annular PEEK ring seals at least one face of the frit at a peripheral edge of the frit, and preferably seals both faces at that edge.

### CROSS-REFERENCE TO RELATED APPLICATIONS

The application claims the benefit under 35 U.S.C. §119(e) to Provisional Patent Application No. 61/723,251 filed Nov. 6, 2012, the entire contents of which are incorporated herein by reference.

### STATEMENT RE: FEDERALLY SPONSORED RESEARCH/DEVELOPMENT

Not Applicable

### BACKGROUND

Chromatography is one of the most widely used analytical tools in pharmaceutical, chemical manufacturing, environmental, and clinical toxicology laboratories. It is a process where a mixture of different chemicals is separated into is substituent components for detection and quantification. One of the main components to a chromatographic system is the chromatographic column. Inside the column there is a chemically modified sorbent, known as the stationary phase. A liquid this then pumped through the column, also known as the mobile phase. The separation occurs because each chemical compound has a different affinity for the mobile phase versus the stationary phase.

In order to keep the stationary phase inside the tubular column or other container, a mechanical filter is placed at the ends of the tube or column or other container. These filters are also called frits or screens. These frits have to be fine enough to hold the stationary phase, but permeable enough to allow the mobile phase and analyte molecules to permeate through. The stationary phase may have particles a few microns diameter, or smaller. Along with retaining the chromatographic media in the column, the filters or frits also act as a physical filter excluding particulate contamination that may be present in the sample or the mobile phase, or that are generated by degradation of the particles.

One side effect of filtering out particulate containing samples is that debris and particulates build up on the filter media. This buildup is especially noticeable if biological fluids are being analyzed as the biological material may fragment into smaller particles which are blocked by the filter. After enough of the particulates have has accumulated on the filter media one of two common side effects may be realized. The first side effect is that the operational pressure of the column will increase as the filter becomes clogged, making it more difficult for the mobile phase to pass through the clogged filter, and causing an increase in the operational pressure. At some point the clogging may cause the operational pressure or back pressure to exceed the system pressure limitations. The second common side effect of a clogged filter is that the filter's pores or passageways have restricted access, which subsequently causes turbulent flow for at least the filter interface and that may cause wide or split chromatographic peaks.

To alleviate these difficulties some columns have been developed using depth filters having graded pore sizes which decrease in the direction of flow through the column during use. Such filters are described in U.S. Pat. No. 5,985,140, the complete contents of which is incorporated herein by reference. As a debris particle enters the wider, upstream opening in the filter it becomes trapped in the filter as the interstitial passages narrow, but fluid flows around the trapped particle. But such filters also clog and have a noticeable pressure increase and noticeable efficiency loss after about 60 injections, depending on the application.

### BRIEF SUMMARY

A frit, filter or screen is made of non-woven sintered fibers of metal, preferably stainless steel. The fibers are progressively more densely packed in opposite direction of flow, or more loosely packed in the direction of flow. This results in progressively increasing pore sizes which are the interstitial spaces between the fibers. The increase in interstitial clearance may be attributable to a lesser number of fibers per unit volume on the downstream side of the frit, or to the use of fibers of a progressively smaller diameter on the upstream side and progressively larger diameter on the downstream side of the frit. Most conveniently, however, fibers of a single diameter are used, and the variation is created by stepwise changes in the packing density of the fibers with the fibers being more dense on the upstream side and less dense on the downstream side, at least for the frit on the upstream end of the column during use. In any event, the interstitial clearance on the upstream side of the frit during use begins as a very small diameter or size sufficient to retain the debris associated with whole blood and the interstitial clearance enlarges on toward the downstream side of the frit.

Other relevant aspects of the frit 10 are its thickness and permeability factor, both of which may vary as may the pore size or interstitial passage size. The thickness in most cases will be within the range of from about 0.1 mm to about 1.0 mm, preferably from about 0.2 mm to about 0.6 mm, and most preferably from about 0.3 mm to about 0.6 mm. The permeability factor k is defined by Darcy's Law in which the change in pressure P divided by the thickness of the frit L equals the fluid viscosity times the superficial velocity divided by the permeability factor K. The permeability factor in most cases will be within the range of from about 4×10¹³ to about 1×10⁻¹⁰ m², preferably from about 4×10⁻¹³ to about 1×10⁻¹¹ m², and most preferably from about 4×10⁻¹³ to about 4×10⁻¹² m², when measured in the direction of fluid flowing from the largest to the smallest interstitial passages.

The gradation in interstitial passages may be stepwise or continuous, and the variation from the smaller-pore side to the larger-pore side may vary widely. The pore size differential (i.e., the difference between the largest pore size and the smallest pore size) may thus range from about 1 micron to about 50 microns, or preferably from about 2 microns to about 20 microns. The frit gradations may be continuous or stepped. The frit 10 may contain two or more stepped gradations and preferably three to six stepped gradations. The pore size on the course (downstream) side of the frit (the coarsest portion of the frit) may range from about 2 microns to about 50 microns, preferably from about 2 microns to about 6 microns. The pore size on the finer, upstream side of the frit 10 is smaller than the downstream side, preferably by a factor of about 2 or more, and more preferably by a factor of up to 10 times smaller.

The strands of metal may have a cross-sectional dimension of about 2-20 μm, and each frit 10 preferably has stands of substantially the same dimension and lying in substantially the same plane. The frits are preferably thin, having a thickness from about 10-200 strands thick, although thicker frits can be used. The frit is held in a recess of an end fitting, insert or elastomeric holder (preferably PEEK). An annular elastomeric (preferably PEEK) ring seals at least one face of the circular, disk-shaped frit at a peripheral edge of the frit, and preferably seals both faces at that edge to provide a fluid tight seal at the periphery which forces fluid through the frit rather than around the outer periphery of the frit.

This frit material is used to retain chromatographic media inside of chromatography columns and cartridges. The filtration properties of this frit are believed to allow for an extended lifetime of chromatographic columns and cartridges under certain conditions. In particular, the described filter or frit retains the chromatographic media while resisting fouling due to dirty samples, yet also provides a seal between the column tube, frit, and end fitting.

Most popular frits for retaining chromatographic media are made by sintering a stainless steel or titanium metal powder. The frit's porosity and pore structure is therefore dictated by the size and size distribution of the powdered particles used to make a “green” body, the pressure at which the “green” body is pressed, and the temperature used for sintering. The preferred starting material for the preferred frit is a stainless steel, titanium, or nickel metal fiber with a width of 2-20 μm. The fiber is sintered in a random arrangement but with the fibers or strands arranged in generally the same plane as the thin frit, rather than having the fibers or strands extend predominantly in axial directions perpendicular to the plane of the frit. The fibers are also randomly arranged within the above angular orientations and form non-woven, fiber layers. This non-woven arrangement is believed to be beneficial. Very thin layers of the metal fibers are believed to be particularly desirable, with the layer thickness being on the order of 0.010-0025050 inches (0.254-0.063627 mm) thick. But, thicker layers can be used if particulate retention is an issue.

This material may be used in sandwich configurations where it is trapped between two layers of woven wire mesh. This is believed to be an inferior adaptation of this material for two reasons. The first is that the abrupt change in flow resistance and pore structure between the woven wire mesh material and the non-woven material can cause flow uniformity manifested by chromatographic peak tailing. The second is that it is believed to allow for chromatographic materials to potentially escape around the outside of the frit, because the seal is formed on the woven mesh side and that may allow silica to pass through.

In the preferred frit only a thin layer of sintered fiber material are used in conjunction with a PEEK seal around the peripheral edge of the frit and that seals directly with the fiber material. The PEEK seal can be molded, sonically welded, sandwiched, or just inserted as a gasket. Specific examples of available configurations are shown in the exemplification section.

Further, it is usually advantageous to spread the sample across the surface of the frit. While the orientation of the fibers within the frit itself will distribute the sample laterally, it is preferred to also have a distribution cone that has an angle of 3-10° from the longitudinal flow axis through the frit, or a distribution disk placed against or next to the frit to further distribute the sample.

There is thus provided a chromatography column having: a rigid cylindrical tube defining a separatory media chamber and a direction of flow of carrier fluid therethrough during use of the column. The column has a pair of media-retaining frits. One of the frits borders the chamber at an upstream end thereof and the other frit borders the chamber at a downstream end thereof. The frit at the upstream end preferably comprises sintered, non-woven stainless steel fibers of graded interstitial passages increasing in size in said direction of flow. The column also has a pair of end fittings, each fastened to an opposing end of the column and configured to place the column in fluid communication with equipment during use of the column.

In further variations, the graded insterstitial passages on the upstream side of the upstream frit are small enough to retain particles 10 microns in diameter, preferably small enough to retain particles 5 microns in diameter, more preferably are small enough to retain particles 3 microns in diameter, and ideally small enough to retain particles about 1 micron in diameter. Moreover, the graded insterstitial passages on an upstream side of the frit are advantageously small enough to retain particles from 1-3 microns in diameter. Further, the graded insterstitial passages on an upstream side of the upstream frit are small enough to retain particles 5 microns in diameter with the upstream frit having a thickness of from about 0.1 mm to about 1.0 mm and a permeability factor of from about 4×10⁻¹³ to about 1×10⁻¹⁰ m² with the permeability measured in the direction of larger to smaller interstitial passages.

I still further variations, the graded insterstitial passages on the upstream side of the upstream frit are small enough to retain particles 1-3 microns in diameter and the upstream frit has a thickness of from about 0.1 mm to about 0.6 mm and a permeability factor of from about 4×10⁻¹³ to about 1×10⁻¹² m² with the permeability measured in the direction of larger to smaller interstitial passages.

There are also provided various means for holding the upstream and/or downstream frits in position in the column. These means are described in more detail herein, and include clamping a periphery of the frit against a ledge on the inside of the column (FIG. 1c); placing the frit in a recess (preferably tapered) with a flat, annular washer (preferably of PEEK) around a periphery of the frit to hold the periphery in the recess when an end fitting abuts the washer (FIG. 2); placing the upstream frit in a recess (preferably tapered) with a flat, annular washer (preferably of PEEK) around a periphery of the frit with a notch in the inner periphery of the washer to hold the upstream, outer peripheral edge of the upstream frit in the recess when an end fitting abuts the washer (FIG. 3), with the orientation being reversed for the downstream frit; placing the upstream frit in a circular recess in an upstream side of a cupped washer (preferably of PEEK) with the bottom of the circular recess tapered to one or more fluid passageways, so an end fitting abuts the outer periphery of the cupped washer which deforms to clamp the frit in the cupped washer during use (FIG. 4) with the orientation being reversed for the downstream frit; placing the upstream frit on a bottom of a recess in the fitting (bottom may be slightly conical) and placing a flat, annular washer (preferably of PEEK) around the outer periphery of the frit with the washer having a notch around its inner periphery forming an inward extending flange on the upstream side of the frit that overlaps the periphery of the frit so that an end fitting abutting the washer holds the frit in place (FIG. 5) with the orientation being reversed for the downstream frit; resting the upstream frit on a circular boss formed in the bottom of the end fitting with an annular groove around the outer periphery of the boss with an O-ring (preferably of PEEK) abutting the peripheral edge of the frit or enclosing the peripheral edge or fitting into a groove on the peripheral edge to seal that peripheral edge, with the O-ring fitting into the groove so that an end fitting abutting the O-ring holds the frit in position and seals the peripheral edge of the frit (FIG. 6), with the construction being reversed in orientation for the downstream frit; placing the upstream frit in a circular recess in a cup-shaped washer (preferably of PEEK) having a plurality of radial slits in the circular bottom forming fluid passages, such that the sidewall of the washer may have an inwardly extending flange to overlap the outer periphery of the frit received in that circular recess (FIG. 7), with the cup-shaped washer in turn placed on a flat bottom of the end fitting or a mating recess in the end fitting, such that the end fitting abuts the periphery of the cup-shaped washer it helps seal the periphery of the washer to the frit and the periphery of the washer to the bottom of the end fitting, with the orientation of parts being reversed for the downstream frit; and an insert having a recess shaped to receive the frit, with the insert configured to accommodate any of the above means for holding the frit and sealing a peripheral edge of the frit during use, the insert mating with other equipment to position the frit, and possibly fitting inside a tube to position the insert and frit (FIG. 8).

The end fitting abutting the various washers and bodies also enhances the formation of a fluid tight seal around the peripheral edge of the frit held by the washer or body. Thus, each of the above described means for holding the upstream and/or downstream frits in position in the column, also provide means for sealing a peripheral edge of the frit during use.

The above chromatography column may be used with any downstream frit, or it may be used with a frit having a graded porosity, advantageously with the graded porosity frit oriented so larger passageways in the downstream frit are closer to the media in the chromatography column than the smaller passageways in the frit, but is preferably orientated so that smaller passageways in the downstream frit are closer to the media in the chromatography column than the larger passageways in the frit.

There is also provided a chromatography method using a chromatography column with a media bed therein and a frit on opposing ends of the media bed. The method includes injecting a fluid sample containing an analyte into an upstream end of the column and passing the sample and analyte through the upstream frit, where the upstream frit has a graded porosity and is oriented such that larger interstitial passageways in the upstream frit are further away from the media than the smaller interstitial passageways in the upstream frit. The method also includes passing at least some of the analyte through the frit on the downstream end of the column. The method may also include analyzing the analyte chromatographically. The upstream frit is formed of sintered, non-woven stainless steel fibers of graded interstitial passages decreasing in size in said direction of flow during use of the column.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1a shows a scanning electron microscopic images of the sintered metal fiber at a magnification of 500×;

FIG. 1b shows a scanning electron microscopic images of a portion of the sintered metal fiber of FIG. 1 at a magnification of 1,000×;

FIG. 1c shows a cross-sectional view of a chromatography column using the frit of FIGS. 1a and 1b;

FIG. 2 shows a cross sectional view of a frit as described herein located in an HPLC end fitting using a washer and a distribution cone;

FIG. 3 shows a cross sectional view of a frit as described herein located in an HPLC end fitting using a washer and a distribution disk.

FIG. 4a shows a cross sectional view of a frit as described herein located in an HPLC end fitting using a molded seal and a distribution cone;

FIG. 4b shows a perspective view of the seal of FIG. 4a without a frit in it;

FIG. 5 shows a cross sectional view of a frit as described herein located in an HPLC end fitting using a washer with a location relief in the washer, with a partially exploded view of the washer and frit;

FIGS. 6a and 6b show a cross sectional view of a frit as described herein located in an HPLC end fitting using an O-ring, with a partially exploded view of the frit and O-ring;

FIG. 6c shows a cross-sectional view of the frit and O-ring of FIGS. 6a and 6b;′

FIG. 6d shows various connections between the frit and O-ring of FIGS. 6a-6b;

FIG. 7a shows a cross sectional view of a frit as described herein located in an HPLC end fitting using a carrier with flow distribution features;

FIG. 7b is a cross sectional view taken along section 7b-7b of FIG. 7c;

FIG. 7c is a bottom elevation view of the frit and filter of FIG. 7b;

FIG. 7d is a top elevation view of the frit and filter of FIGS. 7a and 7b;

FIG. 8 shows a cross sectional view of a frit as described herein located in an HPLC end fitting using a carrier with a distribution cone;

FIG. 9a is a side elevation view of a further embodiment of the frit and fitting of FIG. 32; and

FIG. 9b is a cross-sectional view taken along section 9b-9b of FIG. 9a.

### DETAILED DESCRIPTION

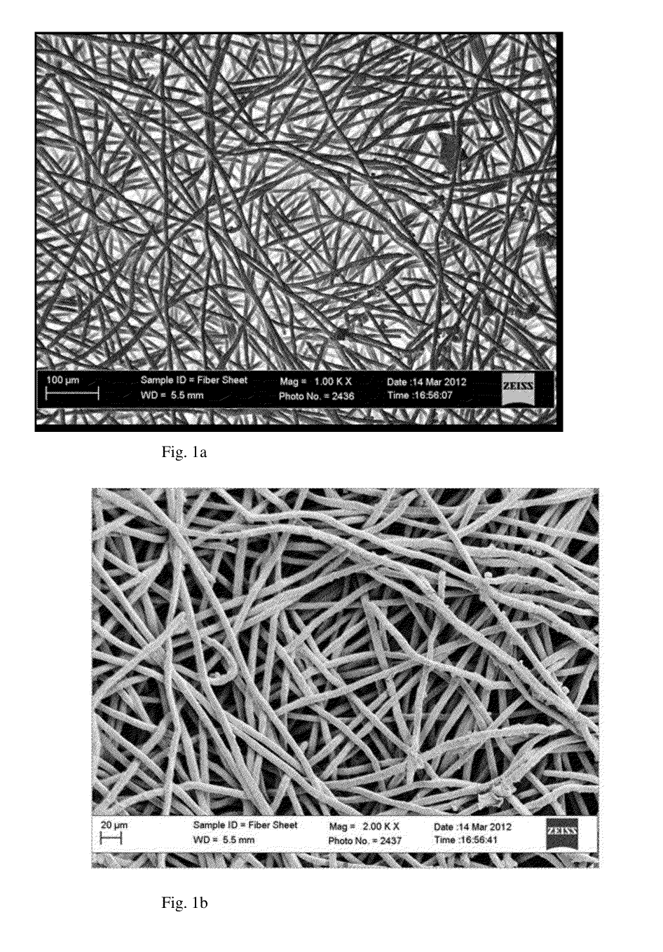

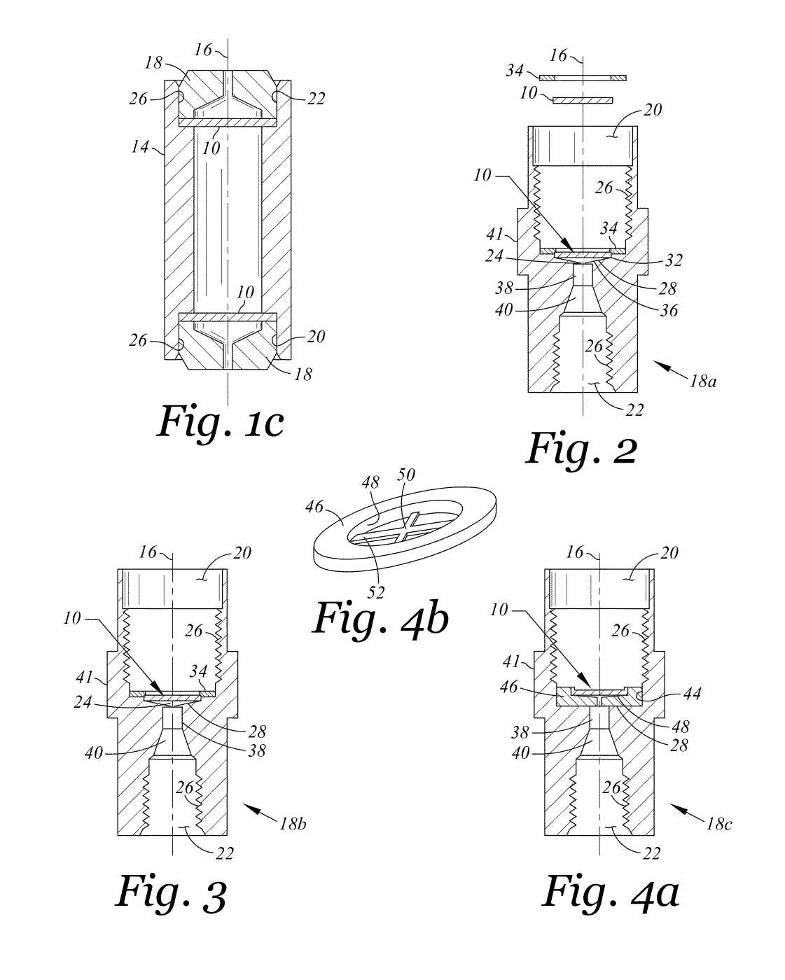

Referring to FIGS. 1-2, a filter or frit 10 is provided that is suitable for use with chromatographic columns and containers, especially HPLC columns. The frit 10 is made of non-woven strands 12 of material, preferably randomly oriented. The preferred materials for strands 12 are stainless steel, titanium, or nickel metal fiber. The strands 12 may have a cross-sectional dimension of about 2-20 μm. Advantageously, the strands 12 in a single frit 10 have substantially the same cross-sectional dimension, preferably circular. As used herein, substantially the same cross-sectional dimension means a variation in the average of the largest cross-sectional dimension is about 50% or less, ignoring localized discontinuities that may present larger or smaller dimensions. The frits 10 are typically cylindrical discs and the strands 12 have a length that preferably extends for about half or more of the diameter of the disc.

The frit material is advantageously sintered non-woven stainless steel fibers. The particular stainless steel is not believed to be critical to the invention, and a variety of different stainless steel alloys can be used. Austenitic stainless steels, i.e., those whose chief alloying elements are chromium and nickel, are preferred. A particularly preferred stainless steel is 316L stainless steel, whose composition is approximately 0.03% carbon, 2.00% manganese, 1.00% silicon, 16.0-18.0% chromium, 10.0-14.0% nickel, 0.45% phosphorus, 0.03% sulfur, and 2.0-3.0% molybdenum (all percents by weight).

A currently preferred frit medium is BEKIPOR® ST filter medium, and in particular BEKIPOR® ST 3AL3, a product of NV Bekaert SA of Belgium, available through Bekaert Fibre Technologies Europe, Zwevegem, Belgium, and Bekaert Corporation, Atlanta, Ga., USA. This medium is made of 316L stainless steel fibers, randomly compressed in a non-woven structure and sintered, and is supplied in sheets, with typical lateral dimensions of 1180 mm.times.1500 mm and 0.35 mm in thickness. This particular product has an absolute filter rating of 3 microns, a bubble point pressure of 12,300 Pa (ASTM E 128061, equivalent ISO 4003), an average air permeability of 9 L/dm.sup.2/min at 200 Pa (NF A 95-352, equivalent IOS 4022), a permeability factor k of 4.80.times.10.sup.-13, a weight of 975 g/m.sup.2, a porosity of 65%, and a dirt holding capacity of 6.40 mg/cm.sup.2 according to Multipass method ISO 4572 with 8″ initial differential pressure—all when the frit is reversed from its use as described herein so that fluid flows from the larger interstitial passages toward the narrower passages. Other media of similar characteristics and made of similar materials can also be used.

When used in the chromatography column 14 as described herein, the frit 10 is orientated so that the gradation of the pore size during use is such that the debris-containing sample fluid enters the frit through the side with the smaller interstitial spaces, passes through the frit, and leaves the frit through the side with the larger interstitial spaces. The larger pore sizes and passageways are toward the media contained by the frit 10. The degree and spatial rate of gradation of size may vary within the scope of this invention, as may the pore sizes themselves. Best results however are believed to be obtained with a pore size gradation that begins with a size that is narrow enough to retain particles that are 10 microns in diameter, preferably 5 microns in diameter, and most preferably 1 to 3 microns in diameter, all on the upstream side of the frit during use. The downstream side of the frit has larger pore sizes, openings or interstitial spacing than the upstream side—at least for the upstream frit 10a.

As used herein, the relative directions top and bottom refer to the orientations of the parts as shown in the drawings, with top usually being in the vertically upward direction. The upstream and downstream directions refer to the direction of fluid flow through the chromatographic column 14 during use.

As sheets of the filter medium are supplied by commercial suppliers of the medium, the side with the larger pore size is frequently differentiated by being colored or otherwise marked to guide the user in obtaining the desired orientation. In the drawing, the frit at the upstream end of the column during use has the frit oriented so the smaller pore size is also located upstream during use. Since the frit medium is thin and flexible, mechanical support is preferably provided to assure that the frit medium remains flat. Several examples of frit supports are described later.

In use a frit 10 is placed at upstream or top end of a chromatographic column 14 having a longitudinal axis 16. The chromatography column 14 comprises a tube, typically of metal such as stainless steel, having a media chamber therein containing media bounded by frits 10, with end caps or end fittings holding the frits in place and placing the column in fluid communication with chromatography equipment during use. The tube, especially when packed with media, is rigid. The column 14 may take the form of an elongated column as shown, or it may comprise a guard column, or it may comprise a guard cartridge in which the tubular column is inserted within another tubular column upstream of another column or cartridge. The reference to a chromatography column thus encompasses both columns and cartridges unless noted otherwise.

The frit 10 may optionally also be placed on the downstream end of the column 14, or other filter types may be used on the downstream end. The downstream end of the column 14 may also have a depth filter with the filter in either orientation. Thus, the column 14 has upstream frit 10a in the form of a depth filter with the interstitial passages or pore size of the filter increasing in the direction of flow. That is contrary to the conventional wisdom of using a depth filter in the reverse orientation where the interstitial passages decrease in size the direction of flow. The downstream frit 10b may be any type of filter, with a non-graded, woven metal filter being believed suitable, with a depth filter having the interstitial passages decreasing in size in the direction of flow being believed usable, and with a depth filter having the interstitial passages increasing in size in the direction of flow being believed usable and believed preferable.

When the frit 10 is used as described herein on the upstream end of the chromatography column or a bed of chromatography media a surprising improvement in the life of the column is achieved. Comparative tests indicated that the rate of column backpressure increase was the about the same regardless of which side of the frit 10 was facing the packing media. The columns 14 with the fine side of the frit 10 facing the packing material in the column took about twice as long to reach a failure state versus standard frits of sintered powder metal, whereas the columns 14 with the fine side of the frit 10 facing away from the packing material in the column took 3 times as long to reach a failure state. A failure state was defined as the loss of 50% of the chromatographic performance of the column, or a backpressure of 400 bar. This shows that it is better to have the coarse side of the graded porosity frit 10 facing the packing material and the fine side of the frit 10 facing away from the packing material. This frit orientation is contrary to the orientation taught in the prior art and goes against the teachings of the prior art.

The frit 10 has a thickness measured along that longitudinal axis that may vary, but which is preferably thin, on the order of a few thousandths of an inch thick, preferably from about 0.01-0.003 inches (0.25-0.07 mm) thick. But thicker frits 10 may be used if particulate retention is an issue, and if the frit 10 is sandwiched between additional screens or filters the thickness may also increate. Since the strands 12 used in the frit are from 2-20 μm thick, while the frit is from about 0.06 to 0.25 mm thick, anywhere from a few strands to a couple hundred strands may be stacked in generally parallel planes in order to each other to achieve the axial thickness. For example, at 0.2 μm thick, 127 strands create a frit 10 with a thickness of about 0.25 mm, and 32 strands with a thickness of about 0.20 μm create the same thickness. Using strands with a thickness of about 20 μm, from 3 to 13 strands can create the same thickness. Thus, only thin layers of the non-woven metal fibers or strands 12 are advantageously used, with thinner frits 10 being preferred for chromatographic reasons—as long as the frit functions of particulate retention and specified (preferably low) back pressure are met.

As seen in FIGS. 1-2, the strands 12 are seldom perfectly straight, buy have numerous crooks, bends and angles, with occasional reversals in direction. The strands 12 are nonwoven and preferably randomly oriented, but extend predominantly along directions from edge to edge of the frit, rather along the longitudinal axis 16. Thus, the strands 12 are in the same general plane of the frit, rather than perpendicular to the plane of the frit as is axis 16. The frits 10 for chromatography columns are small in diameter, corresponding to the size of the bore of the chromatography column or being slightly larger, depending on how the fit 10 is mounted. Diameters of a few millimeters are common, and may be less than a mm.

The strands 12 are non-woven and preferably randomly stacked and then sintered to form the frit 10. This non-woven arrangement is an important distinction, as there are several woven screen arrangements available using metal strands. The orientation of the frit 10 with the smaller interstitial passages on the upstream end during use is also an important distinction, as it is the opposite of the arrangement described for the depth filter of U.S. Pat. No. 5,985,140. But these prior art frits do not provide the same filtration performance as the described frit 10, as discussed later.

The downstream frit 10 may be a screen or filter with uniform porosity and distribution, it may comprise a depth filter with the larger pores, openings or fiber spacing located on the upstream side and decreasing in size toward the downstream side as with a traditional depth filter, or with the smaller pores and spacing on the upstream side and increasing toward the downstream side.

Referring to FIG. 2, the frit 10 is placed in end fitting 18a having opposing recesses 20, 22 in opposing ends of the end fitting and in fluid communication through passage 24.Both recesses 20, 22 typically have internal threads 26 sized and configured to mate with various equipment. The column recess 20 is sized and has threads 26 configured to mate with an end of a chromatography column 14 (not shown). The column recess 20 has a bottom 28 onto which through passage 24 opens, with two, stepped, circular recesses (30, 32) adjacent that bottom 28. The recesses 30, 32 are annular, stepped recesses. The first stepped recess 30 has as its bottom, bottom 28 and the stepped recess 30 is sized to receive the filter or frit 10 and is preferably centered on through passage 24 and longitudinal axis 16. The second stepped recess 32 encircles stepped recess 30 and is sized to receive a flat, annular washer of elastomeric material, preferably PEEK. Recesses 30, 32 are preferably cylindrical and sized diametrically to allow the frit 10 and washer 34 fit snugly in the recess and sized axially to allow the washer 34 to compress against the outer periphery of the frit 24 and provide a fluid tight seal. The annular washer 34 has an inner diameter that is smaller than the outer diameter of the frit 10.

In use, the end of a column 14 and end fitting 18a are threaded together using threads 26 with the end of the column abutting washer 34 and pressing the washer against the periphery of frit 10 to form a fluid tight seal. The frit 10 is oriented so the smaller openings are upstream and larger openings downstream during use of the column 14. This same orientation is used on all upstream frits 10 in columns 14 and may not be repeated through the detailed description of various embodiments. The inner periphery of washer 34 overlaps the outer periphery of the frit 10 and is pressed against and seals against the frit in order to prevent analyte or particles from passing between the outer periphery of the frit and the first recess 30 and past the washer 34. The washer 34 and frit 10 in the described arrangement thus provide a fluid tight seal. The overlap of the washer 34 and the frit 10 also helps prevent small particulates from getting underneath the washer 34 and passing around the outer periphery of the frit 10.

Advantageously, the first stepped recess 30 is not orthogonal to the longitudinal axis 16, but is slightly inclined away from the column and toward the axis 16 and toward recess 22 in order to form a shallow conical surface having an inclination of about 4° and sloping toward the recess 22. The shallow angle helps distribute fluid passing through the through passage 24, across the frit 10 so the fluid more evenly spreads across the end of the column abutting the washer 34. The tightening of the end fitting 18a may deform the outer portion of the frit toward this conical surface but that does not prevent the conical distribution surface from more evenly distributing the fluid across the frit 10. The PEEK washer 34 may be thin measured along axis 16, with a thickness of about 0.003 inches (0.076 mm) or large believed suitable.

Still referring to FIG. 2, the inlet recess 22 is configured to mate with various chromatography equipment so the precise dimensions will vary. Advantageously the inlet recess 22 has a bottom 36 on which the thru passage 24 is located. An optional but commonly used cylindrical recess 38 extends from bottom 36, with an option but commonly used conical transition section 24 extending between the cylindrical recess 38 and the threaded portion of inlet recess 22. Typically, a flexible silica tube (not shown) fits into cylindrical recess 38 and is held in place by engaging threads 26 in recess 22 in order to place column 14 (not shown) in fluid communication with various chromatography equipment (not shown).

While the above description of end fitting 18a refers to inlet fitting 22, the same construction may be used for an outlet coupling, with the inclined wall 30 funneling filtered fluid to the outlet recess 22, rather than distributing it over the frit 10. A gripping or wrenching surface 41 is typically provided on the outside of the end fitting 18a so a user can use the surface 41 to tighten the end fitting 18a to the desired equipment using threads 16.

Referring to FIG. 3, an end fitting 18b is provided. The construction of end fitting 18b is like that of 18a except that the bottom of the first stepped recess 30 is not slightly conical and is instead orthogonal to the longitudinal axis 16. Further, a diffusion disk 42 is inserted between the frit 10 and the bottom 28 of the first stepped recess 30. The depth of the stepped recess 30 will be adjusted to accommodate the disk 40. The diffusion disk is typically a sintered metal disk that diffuses fluids laterally in the plane of the disk and is used to help spread fluids over the diameter of the frit 10.

In use, the end of a column 14 and end fitting 18b are threaded together using threads 26 with the end of the column abutting washer 34 and pressing it against the periphery of frit 10 to form a fluid tight seal between those two parts. The threading also pushes the frit 10 against the diffuser 42 and against the bottom 28. The inner periphery of washer 34 overlaps the outer periphery of the frit 10 and is pressed against and seals against the frit in order to prevent analyte or particles from passing between the outer periphery of the frit and the first recess 30 and past the washer 34. The washer 34 and frit 10 in the described arrangement thus provide a fluid tight seal. The overlap of the washer 34 and the frit 10 also helps prevent small particulates from getting underneath the washer 34 and passing around the outer periphery of the frit 10 and diffuser 42.

Referring to FIG. 4, an end fitting 18c is provided. The construction of end fitting 18c is like that of 18a and 18b, but with the bottom of the first stepped recess 30 being orthogonal to the longitudinal axis 16. Further, the stepped recesses 30, 32 are combined in to a single recess 44 having bottom 28 with the recess sized to receive a holder 46. The holder 46 may be shaped like a disc with a cylindrical recess 48 in one face of the disk and sized to snugly receive frit 10 therein. The recess 48 is located in the face of holder 46 that faces away from bottom 28 and recess 22. The holder 48 has a hole 50 on axis 16. The hole 50 is preferably conical, tapering outward from axis 16 at an angle of a few degrees and expanding toward the recess 22. Thus, the hole 50 is smaller at the recess 48 than at the bottom surface abutting bottom 28.

Further, end fitting 18c may have the through-hole 24 and the structure forming that hole 24 omitted so the cylindrical wall 38 opens directly into bottom 28 and the first recess 20. Moreover, as seen in FIG. 4b, the bottom of recess 48 in the holder 46 may be slightly tapered at an angle of a few degrees (about 4° is preferred), with the taper toward the axis 16 and toward the second recess 22. Further, shallow grooves a few thousandths of an inch deep and wide may be placed in the bottom of the recess 44 in order to direct fluid along the bottom to and away from the central The holder 46 is made of an elastomeric material, preferably PEEK, with the recess 44 sized to snugly receive frit 10 during use. The recess 48 in the holder 46 is deeper than the frit 10 is thick, so the recess 48 extends beyond the thickness of the frit.

In use, as the end fitting 18c is tightened on the end of a column (not shown in FIG. 4a) using threads 26, the holder 46 is deformed so it deforms slightly over the outer periphery of the frit 10 to seal against the outer puerperal surface of the frit 10, and to preferably also seal against the outer cylindrical edge of the frit 10. The deformation of the holder 46 provides a fluid tight seal around the frit 10, and prevents particulates from passing around the outer peripheral edge of the frit. A silica tube is placed in cylindrical recess 38 with the tube's end abutting the bottom of holder 46 to place the hole 50 in fluid communication with chromatography equipment. As fluid is introduced through-hole 50, the grooves 52 and tapered surface of the bottom of recess 48 disperse the fluid across the frit 10. If the flow is in the opposite direction, then the tapered bottom of the recess 48 and grooves 52 help direct the fluid to the hole 50 and the equipment connected to recess 22. Please note that the grooves 52 and tapered, conical bottom in recess 48 are optional, but are preferred as they are believed to aid fluid flow and distribution. SUITABLE MATERIALS OTHER THAN PEEK? HOW CLOSE IS THE FIT AT THE OUTER PERIPHERY OF THE DISK-SHAPED FRIT?

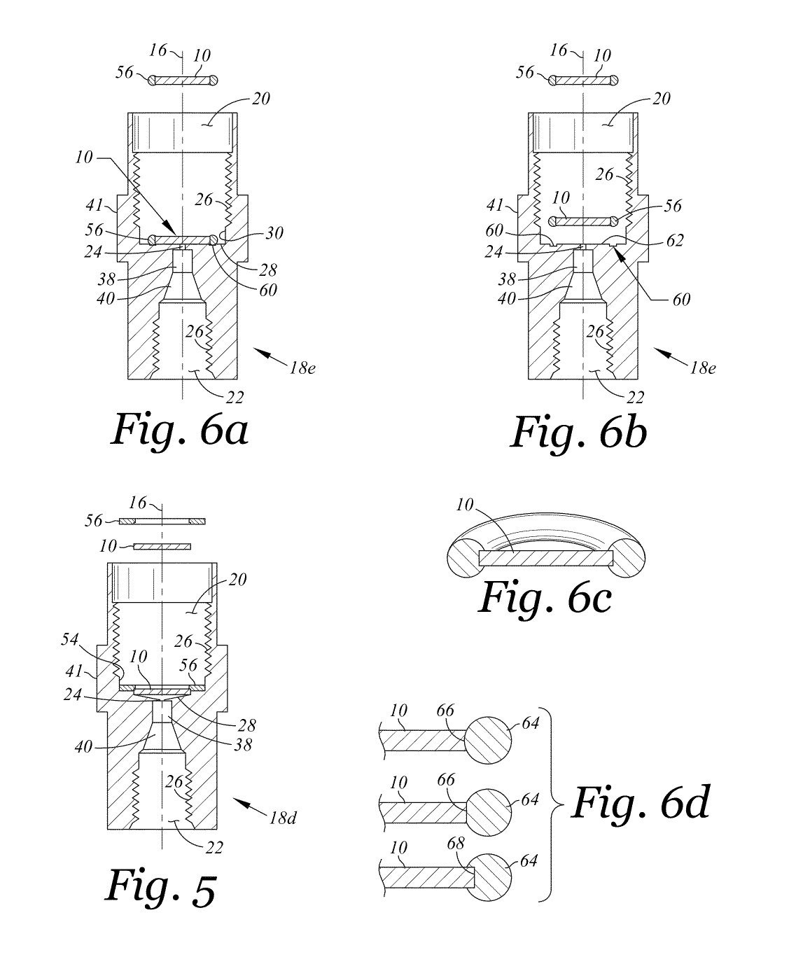

Referring to FIGS. 5a-5b, an end fitting 18d is provided. The construction of end fitting 18d is like that of 18a with the bottom 28 being slightly conical in shape and narrowing toward the through-hole 24. Rather than two stepped recesses the column recess 20 has a single recess 54 the bottom of which is formed by bottom 28. A holder 56 has an annular recess 58 in one of its faces with the recess shaped to snugly receive frit 10. In contrast to holder 46 and its recess 48, the recess 58 is in the surface of the holder 56 that faces bottom 28 and faces toward recess 22. Further, the recess 58 is annular with a large center hole effectively providing a notch or flange within which the frit 10 is placed and extending over a small outer peripheral portion of the frit.

In use, as the end fitting 18d is tightened on the end of a column (not shown in FIGS. 5a, 5b) using threads 26, the holder 56 is deformed so the inner periphery of recess 58 deforms slightly over the outer periphery of the frit 10 to seal against the outer peripheral surface of the frit 10, and to preferably also seal against the outer cylindrical edge of the frit 10. The deformation of the holder 56 creates a fluid tight seal around the frit 10, and prevents particulates from passing around the outer peripheral edge of the frit. A silica tube is placed in cylindrical recess 38 with the tube's end abutting the bottom of cylinder 38 to place the through-hole 24 in fluid communication with chromatography equipment. As fluid is introduced into through-hole 24, the tapered surface of the bottom 28 of recess 54 disperses the fluid across the frit 10. If the flow is in the opposite direction, then the tapered bottom 28 helps direct the fluid to the through-hole 24 and the equipment connected to recess 22. Please note that the tapered, conical bottom 28 is optional, but is preferred as it is believed to aid fluid flow and distribution.

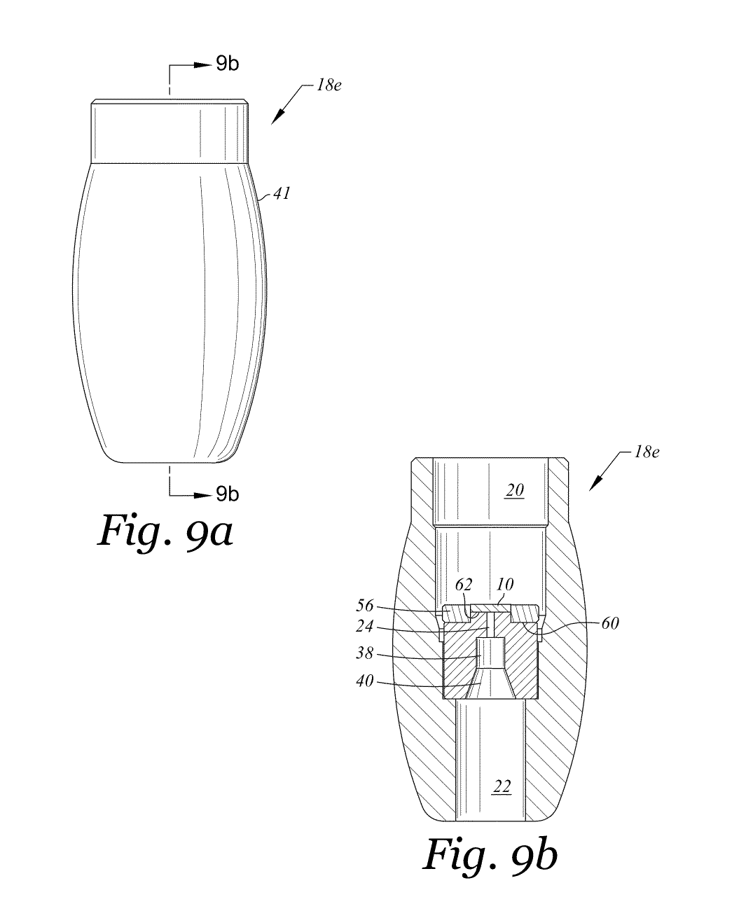

Referring to FIGS. 6a-6c and 9a-9b, an end fitting 18e is provided. The construction of end fitting 18e is like that of 18a, but with the bottom 28 being orthogonal to the longitudinal axis 16 and the recess 20 having a different shaped bottom. The bottom 20 has an annular groove or recess 60 centered on and thus encircling through-hole 24, with the encircled portion of the bottom 28 forming a boss 62 having a flat surface that is preferably, but optionally in the plane of bottom 28. An O-ring 64 is placed in the groove 60 and the frit 10 rests on the boss 62. Advantageously, the shape of the O-ring 64 and groove 60 are complementary such that if the O-ring has a circular or square cross section then the groove 60 in bottom 28 has a mating semi-circular or square cross-section configured and sized to receive the O-ring 64. Further, the depth of the groove 60 is selected so the bottom of the frit 10 rests on boss 62 during use. The boss 62 may optionally have radial grooves or a slight conical shape as described in the bottom of recess 48 of FIG. 4b. FIGS. 9a-9b show that the O-ring forming the seal need not have a circular cross-section, but may have various shapes, the most common of which are square cross-sections and D-shaped cross sections. As used herein, the reference to an O-ring or O-ring seal is to encompass various cross-sectional shapes of the ring seal unless a specific cross-sectional shape is specified.

It is believed preferable to fasten the O-ring 64 to the outer peripheral edge of the frit 10. The abutting parts can be releasably connected by having the O-ring 64 slightly smaller in diameter than the frit 10 so that the O-ring is stretched slightly and squeezes against the edge of the frit 10. A shallow recess or circumferential groove 66 (FIG. 6d) in the edge of the frit 10 may be formed to help prevent an O-ring from slipping out of the groove 66 in the edge of the frit. Alternatively, a shallow grove or recess 68 around the inner circumference of O-ring 64 may be formed to enclose the peripheral edge of the frit as shown in FIG. 6d. Advantageously the grooves 66, 68 match the shape of the mating portion of the O-ring 64 or edge of the frit 10. The parts may be permanently connected by using an adhesive to bond the parts, or other fastening means can be used such as thermal bonding, sonic bonding, etc. The O-ring 64 is preferably made of PEEK.

In use, as the end fitting 18e is tightened on the end of a column (FIG. 1c) using threads 26. The frit 10 and O-ring 64 are assembled and placed so the O-ring is in groove 60 in bottom 28 with the frit resting against the boss 62. The O-ring is deformed as the end fitting is tightened to the column to provide a sealed surface allowing passage only through the frit 10 and through-hole 24. The resulting seal is believed suitable to create a fluid tight seal around the frit 10 sufficient to prevent particulates from passing around the outer peripheral edge of the frit. A silica tube is placed in cylindrical recess 38 with the tube's end abutting the bottom of cylinder 38 to place the through-hole 24 in fluid communication with chromatography equipment. As fluid is introduced into through-hole 24, the optional tapered surface of the boss 62 disperses the fluid across the frit 10. If the flow is in the opposite direction, then the tapered surface helps direct the fluid to the through-hole 24 and the equipment connected to recess 22. If no taper is provided the fluid from the through-hole 24 passes through the frit, or if flow is in the other direction then fluid passing through the frit passes into through-hole 24. Please note that the tapered, conical bottom 28 in boss 62 is optional, but is preferred as it is believed to aid fluid flow and distribution.

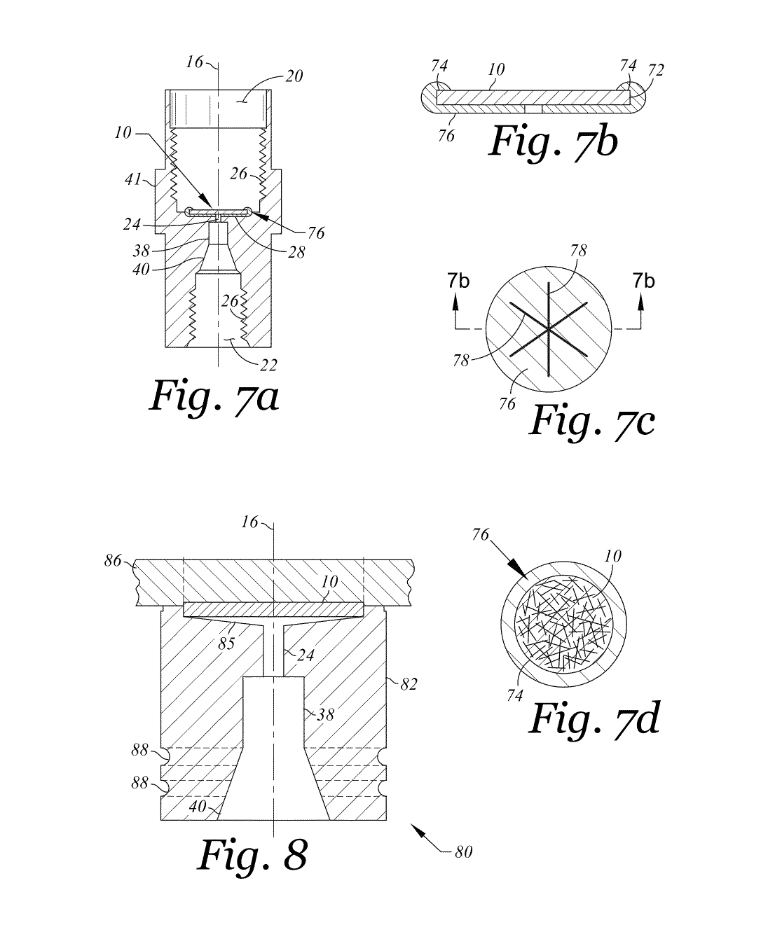

Referring to FIGS. 7a-7d, an end fitting 18f is provided. The construction of end fitting 18f is like that of 18c but with the bottom 28 having a cylindrical recess 70 in the bottom 28 sized to snugly receive a holder 76 that in turn has a recess 72 sized to receive frit 10. The holder 76 is preferably made of PEEK. The recess 72 in holder 76 has its peripheral edge slightly undercut to form a lip or flange 74 that overlaps onto one flat surface of the frit 10. The frit 10 thus rests with one surface against the bottom of the recess 72 in the holder 76 and the opposing surface around the peripheral edge by lip or flange 74. The recess 70 in bottom 28 centers the holder 76 relative to the longitudinal axis 16 and through-hole 24. The bottom of the holder 76 optionally has radial slots 78 (FIG. 7c) extending through that bottom to help direct fluid across the frit 10 during use. The slots 78 intersect at the center of the holder 76, on the axis 16.

In use, as the end fitting 18f is tightened on the end of a column (FIG. 1c) using threads 26. The end of the column maintains the position of the holder 76 and may slightly deform the holder 76 or its lip 74. The holder 76 provides a fluid seal around the periphery of the frit 10 and forces all fluid to pass through the frit. Advantageously the inner periphery of the column abuts the outer periphery of holder 76 to create a fluid tight seal around the holder 76 and frit 10, sufficient to prevent particulates from passing around the outer peripheral edge of the frit or the outer peripheral edge of holder 76. A silica tube is placed in cylindrical recess 38 with the tube's end abutting the bottom of cylinder 38 to place the through-hole 24 in fluid communication with chromatography equipment. As fluid is introduced into through-hole 24, the slots 78 in holder 76 disperse the fluid across the frit 10. If the flow is in the opposite direction, then the slots 78 help direct the fluid to the through-hole 24 and the equipment connected to recess 22. Please note that a tapered, conical bottom on the recess 72 in the holder or on the bottom 28 may be optionally provided to further aid fluid flow and distribution.

Referring to FIG. 8, an insert 80 is provided having a housing 82 with a cylindrical recess 84 at one end. The recess 84 has a bottom 86 onto which opens through-hole 24, which is in fluid communication with cylindrical recess 38 and conical recess 40 as described above. Recesses 38 and 40 are preferably formed in housing 82. The frit 10 is placed in the recess 84. Advantageously, the frit 10 is press fit into the recess 84. The bottom 85 of recess 84 may have an optional taper of about 4° toward through-hole 24 and toward recesses 38, 40, as discussed in other embodiments.

The housing 82 may have an outwardly extending flange 86 on one end to help center the insert inside in the cylindrical body of the column during use and is shown on the top end in FIG. 8. One or more circumferential grooves 88 may be placed on the outside of housing 82, preferably on the end of the housing opposite the flange 86. The grooves 88 are sized and configured to hold O-ring seals (not shown). The flange 86 and O-ring seals engage the inner walls of the tubular column during use to center the frit 10 and through-hole 24 along the longitudinal axis 16.

The housing 82 may be made of elastomeric material or metal, and is preferably of stainless steel. The O-rings are made of rubber, a suitable elastomer or PEEK.

In use, the frit 10 is placed into recess 84 and pushed against the bottom 85. One or more O-rings are placed in grooves 88. The insert 80 is then placed inside an end fitting or inside a tubular chromatography column, with the flange 85 and O-rings in grooves 88 centering the insert along the axis 16. The housing flange 86 and O-rings in grooves 88 are cylindrical and sized to fit inside the end-fitting or chromatography column. The end of the column abuts and seals against the frit 10. Alternatively, any of the fits and seal configurations described in FIGS. 1-7 may be used in the recess 84 and housing 84.

The insert 80 and column are moved relative to each other until the frit 10 is sealed in position in the insert and centered on the axis 16, with the O-rings in grooves 88 providing a fluid seal between the insert 80 and the inside of the end fitting or column into which the insert is placed. A silica tube is placed in cylindrical recess 38 with the tube's end abutting the bottom of cylinder 38 to place the through-hole 24 in fluid communication with chromatography equipment. As fluid is introduced into through-hole 24, the tapered surface of the bottom 85 of recess 84 disperses the fluid across the frit 10. If the flow is in the opposite direction, then the tapered bottom 85 helps direct the fluid to the through-hole 24 and the equipment connected to recess 22. The tapered, conical bottom is optional, but is preferred as it is believed to aid fluid flow and distribution.

The preferred frit for chromatographic use has a very high permeability with filtration characteristics that retain 1-10 μm chromatographic particles, while maintaining the particles' high permeability in the presences of sample that contain high levels of protein, or high levels of particulates.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious, modifications and equivalents thereof. In addition, while several variations of the inventions have been shown and described in detail, other modifications, which are within the scope of these inventions, will be readily apparent to those of skill in the art based upon this disclosure. It is also contemplated that various combination or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

What is claimed is:

1. A chromatography column, comprising:
a rigid cylindrical tube defining a separatory media chamber and a direction of flow of carrier fluid therethrough during use of the column,
a pair of media-retaining frits, one said frit bordering the chamber at an upstream end thereof and the other bordering the chamber at a downstream end thereof, the frit at the upstream end comprising sintered, non-woven stainless steel fibers of graded interstitial passages increasing in size in said direction of flow; and
a pair of end fittings, each fastened to an opposing end of the column and configured to place the column in fluid communication with equipment during use of the column.

2. The chromatography column of claim 1 wherein the graded insterstitial passages on an upstream side of the upstream frit are small enough to retain particles 10 microns in diameter.

3. The chromatography column of claim 1 wherein the graded insterstitial passages on an upstream side of the upstream frit are small enough to retain particles 5 microns in diameter.

4. The chromatography column of claim 1 wherein the graded insterstitial passages on an upstream side of the upstream frit are small enough to retain particles 3 microns in diameter.

5. The chromatography column of claim 1 wherein the graded insterstitial passages on an upstream side of the upstream frit are small enough to retain particles from 1-3 microns in diameter.

6. The chromatography column of claim 1 wherein the graded insterstitial passages on an upstream side of the upstream frit are small enough to retain particles about 1 micron in diameter.

7. A chromatography The chromatography column of claim 1 wherein the graded insterstitial passages on an upstream side of the upstream frit are small enough to retain particles 5 microns in diameter and said upstream frit has a thickness of from about 0.1 mm to about 1.0 mm and a permeability factor of from about 4×10⁻¹³ to about 1×10⁻¹⁰ m² with the permeability measured in the direction of larger to smaller interstitial passages.

8. The chromatography column of claim 1 wherein the graded insterstitial passages on an upstream side of the upstream frit are small enough to retain particles 1-3 microns in diameter and said upstream frit has a thickness of from about 0.1 mm to about 0.6 mm and a permeability factor of from about 4×10⁻¹³ to about 1×10⁻¹² m² with the permeability measured in the direction of larger to smaller interstitial passages.

9. The chromatography column of claim 1, further comprising means for holding at least the upstream frit in position in the column.

10. The chromatography column of claim 1, further comprising means for sealing a peripheral edge of the upstream frit during use.

11. The chromatography column of claim 1, wherein the downstream frit is a graded porosity frit.

12. The chromatography column of claim 1, wherein the downstream frit is a graded porosity frit oriented so larger passageways in the downstream frit are closer to the media in the chromatography column than the smaller passageways in that downstream frit.

13. The chromatography column of claim 1, wherein the downstream frit is a graded porosity frit oriented so the smaller passageways in the downstream frit are closer to the media in the chromatography column than the larger passageways in that frit.

14. A chromatography method using a chromatography column with a media bed therein and a frit on opposing ends of the media bed, comprising:
injecting a fluid sample containing an analyte into an upstream end of the column;
passing the sample and analyte through the upstream frit which has a graded porosity and is oriented such that larger interstitial passageways in while the frit are further away from the media than the smaller interstitial passageways in the frit; and
passing at least some of the analyte through the frit on the downstream end of the column.

15. The chromatography method of claim 14, wherein the upstream frit is formed of sintered, non-woven stainless steel fibers of graded interstitial passages decreasing in size in said direction of flow during use of the column.

16. The chromatography method of claim 14, further comprising analyzing the analyte chromatographically.

17. The chromatography method of claim 15, further comprising analyzing the analyte chromatographically.
